(19) United States
(12) Patent Application Publication
(10) Pub. No.: US 2013/0200808 A1
(43) Pub. Date: Aug. 8, 2013

(54) SENSOR-CONTROLLED SYSTEM AND METHOD FOR ELECTRONIC APPARATUS

(71) Applicant: EMINENT ELECTRONIC TECHNOLOGY CORP. LTD., Hsinchu (TW)

(72) Inventors: TOM CHANG, Taipei City (TW); Kao-Pin Wu, New Taipei City (TW); Chih-Jen Fang, Tainan City (TW); Shang-Ming Hung, Hsinchu County (TW); Fang-Yu Liu, Hsinchu County (TW)

(73) Assignee: EMINENT ELECTRONIC TECHNOLOGY CORP. LTD., Hsinchu (TW)

(21) Appl. No.: 13/733,149

(22) Filed: Jan. 3, 2013

Related U.S. Application Data
(60) Provisional application No. 61/584,177, filed on Jan. 6, 2012.
(60) Provisional application No. 61/702,265, filed on Sep. 18, 2012.

(51) Int. Cl. F21V 23/04

(52) U.S. Cl. CPC F21V 23/0464; F21V 23/0471
USPC 315/152

(57) ABSTRACT

A sensor-controlled system for an electronic apparatus is provided. The electronic apparatus includes at least one light emitting unit. The at least one light emitting unit operates at an emission state and a non-emission state alternately. The sensor-controlled system includes at least one sensor unit and at least one control unit. The at least one sensor unit is arranged for sensing surrounding luminance to generate a sensing signal during a period in which the at least one light emitting unit operates at the non-emission state. The at least one control unit is coupled to the at least one sensor unit, and is arranged for controlling luminous intensity of the at least one light emitting unit according to the sensing signal.

### BACKGROUND OF THE INVENTION

1. Field of the Invention

The disclosed embodiments of the present invention relate to a sensor-controlled system, and more particularly, to a sensor-controlled system capable of turning on an electronic apparatus and adjusting luminous intensity of the electronic apparatus according to surrounding luminance, and a related method.

2. Description of the Prior Art

Compared to incandescent lights and most fluorescent lights, light emitting diodes (LEDs) exhibit higher photoelectric conversion efficiency. In addition, the LED fabrication process uses no material that can potentially cause the greenhouse effect contributing to global warming. As a result, the LED is a necessary light source to achieve energy efficient lighting.

Electronic lighting fixtures (e.g. LED lighting fixtures) need mechanical control devices for activation, deactivation and brightness adjustment. For example, when reading in a study, a reader may turn a control knob to turn on a light and adjust brightness thereof to a comfortable level. As surrounding light intensity may change with time, the reader may have to turn the control knob again to re-adjust the brightness. If the surrounding light intensity is decreased and the reader forgets to adjust the brightness of the light, the reader's eyes will get tired easily. If the surrounding light intensity is increased and the reader forgets to adjust the brightness of the light, this leads to unnecessary energy waste even though the light is a LED lighting fixture. The need for constant manual brightness adjustment will interrupt the reading and lower the user's enjoyment.

Thus, a novel control system of an electronic apparatus is needed to provide a comfortable user experience as well as meeting the energy-saving requirements.

### SUMMARY OF THE INVENTION

It is therefore one objective of the present invention to provide a sensor-controlled system, which is capable of turning on an electronic apparatus and adjusting luminous intensity of the electronic apparatus according to surrounding luminance, and a related method to solve the above problems.

According to an embodiment of the present invention, an exemplary sensor-controlled system for an electronic apparatus is disclosed. The exemplary sensor-controlled system comprises at least one signal generating device, at least one sensor unit and at least one control unit. When the at least one signal generating device is activated, the at least one sensor unit is arranged for sensing a reflected signal reflected from an object and accordingly outputting a first sensing signal. The at least one control unit is coupled to the at least one signal generating device and the at least one sensor unit, and is arranged for controlling the electronic apparatus according to the first sensing signal.

According to another embodiment of the present invention, an exemplary sensor-controlled system for an electronic apparatus is disclosed. The exemplary electronic apparatus comprises at least one light emitting unit. The at least one light emitting unit operates at an emission state and a non-emission state alternately. The sensor-controlled system comprises at least one sensor unit and at least one control unit. The at least one sensor unit is arranged for sensing surrounding luminance to generate a sensing signal during a period in which the at least one light emitting unit operates at the non-emission state. The at least one control unit is coupled to the at least one sensor unit, and is arranged for controlling luminous intensity of the at least one light emitting unit according to the sensing signal.

According to an embodiment of the present invention, an exemplary sensor-controlled method for an electronic apparatus is disclosed. The exemplary sensor-controlled method comprises the following steps: activating at least one signal generating device to generate a detection signal; when the at least one signal generating device is activated, detecting the detection signal which has been reflected, and referring to the reflected detection signal to output a first sensing signal; and controlling the electronic apparatus according to the first sensing signal.

According to another embodiment of the present invention, an exemplary sensor-controlled method for an electronic apparatus is disclosed. The electronic apparatus comprises at least one light emitting unit. The at least one light emitting unit operates at an emission state and a non-emission state alternately. The exemplary sensor-controlled method comprises the following steps: sensing surrounding luminance to generate a sensing signal during a period in which the at least one light emitting unit operates at the non-emission state; and controlling luminous intensity of the at least one light emitting unit according to the sensing signal.

The proposed sensor-controlled system controls a light-dark period of a light emitting unit of an electronic apparatus to lie within persistence of vision time. During a period in which the light emitting unit is at a non-emission state, the proposed sensor-controlled system detects reflected signals, recognizes gestures and/or detects variations of surrounding light by sensors (e.g. a proximity sensor, a proximity gesture sensor and an ambient light sensor). In this way, the highly accurate sensor-controlled mechanism can be realized, and no flickering will be perceived during the brightness adjustment process. Therefore, the energy efficiency of the electronic apparatus can be enhanced further, and a user-friendly and convenient user experience is provided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary sensor-controlled system for an electronic apparatus according to an embodiment of the present invention.

FIG. 2 is a flowchart of an exemplary sensor-controlled method for an electronic apparatus according to an embodiment of the present invention.

FIG. 3 is a diagram illustrating an implementation of referring to surrounding luminance to adjust luminous intensity of the light emitting unit shown in FIG. 1.

FIG. 4 is a diagram illustrating an implementation of a correspondence between a pulse width of a driving signal and signal intensity of a second sensing signal shown in FIG. 3.

FIG. 5 is a waveform diagram illustrating implementations of a driving signal of the present invention.

FIG. 6 is a flow chart illustrating an exemplary sensor-controlled method for an electronic apparatus according to another embodiment of the present invention.

FIG. 7 is a diagram illustrating an exemplary sensor-controlled system for an electronic apparatus according to another embodiment of the present invention.

FIG. 8 is a diagram illustrating an implementation of disposition of the infrared emitters shown in FIG. 7.

FIG. 9 is a flow chart illustrating an exemplary sensor-controlled method for the electronic apparatus shown in FIG. 7 according to an embodiment of the present invention.

FIG. 10 is a diagram illustrating an exemplary disposition of a sensor-controlled system and an electronic apparatus according to an embodiment of the present invention.

FIG. 11 is a diagram illustrating an exemplary disposition of a sensor-controlled system and an electronic apparatus according to another embodiment of the present invention.

FIG. 12 is a diagram illustrating an exemplary disposition of a sensor-controlled system and an electronic apparatus according to another embodiment of the present invention.

FIG. 13 is a diagram illustrating an exemplary sensor-controlled system for an electronic apparatus according to another embodiment of the present invention.

FIG. 14 is a diagram illustrating an exemplary signal generation mechanism of a synchronization signal generation circuit according to an embodiment of the present invention.

FIG. 15 is a diagram illustrating an exemplary signal generation mechanism of a synchronization signal generation circuit according to another embodiment of the present invention.

FIG. 16 is a diagram illustrating an exemplary sensor-controlled system for an electronic apparatus according to another embodiment of the present invention.

FIG. 17 is a diagram illustrating an exemplary television having the sensor-controlled system shown in FIG. 1 according to an embodiment of the present invention.

FIG. 18 is a block diagram illustrating an exemplary sensor-controlled system for controlling the auxiliary light emitting device shown in FIG. 17 according to an embodiment of the present invention.

FIG. 19 is a diagram illustrating an implementation of an operation state of the auxiliary light emitting device shown in FIG. 17 controlled by the sensor-controlled system shown in FIG. 18.

### DETAILED DESCRIPTION

The proposed sensor-controlled system may be employed by any electronic apparatus having turn-on and turn-off operations. In a case where an activated electronic apparatus has a light-emitting function, the proposed sensor-controlled system may further adjust luminous intensity thereof. For clarity and brevity, the following embodiments are described with reference to the control of lighting fixtures. However, a person skilled in the art should understand that the applications of the present invention are not limited thereto.

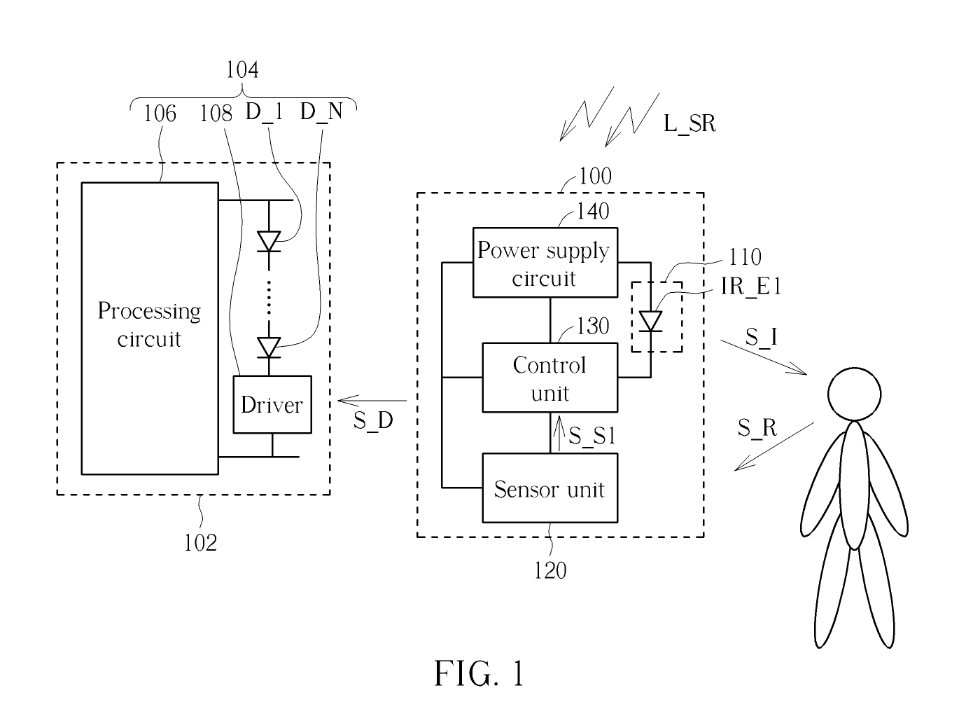

Please refer to FIG. 1, which is a diagram illustrating an exemplary sensor-controlled system 100 for an electronic apparatus 102 according to an embodiment of the present invention. The sensor-controlled system 100 may control the electronic apparatus 102 according to reflected signals reflected from a human body. In this embodiment, the electronic apparatus 102 is a light emitting diode (LED) lighting fixture including a light emitting unit 104. The light emitting unit 104 includes a plurality of LEDs D_1-D_N, a processing circuit 106 and a driver 108. The LEDs D_1-D_N may include light emitters, which convert electrical energy into light energy through solid state devices. By way of example but not limitation, the light emitters are organic LEDs, high power LEDs (HPLEDs), high brightness LEDs (HBLEDs), white LEDs and/or red-green-blue LEDs (RGB LEDs). As a person skilled in the art should understand that the processing circuit 106 may be arranged to perform the input power conversion and other circuit control/protection operations, and the driver 108 may be arranged to drive the LEDs D_1-D_N according to the received driving signal S_D, further description of the processing circuit 106 and the driver 108 is omitted here for brevity.

The sensor-controlled system 100 includes a signal generating device 110, a sensor unit 120, a control unit 130 and a power supply circuit 140, wherein the sensor unit 120, the control unit 130 and the power supply circuit 140 may be implemented by separate integrated circuits (ICs), a single package multi-chip IC or a single IC with integrated functions. The power supply circuit 140 may convert a received input power (not shown in FIG. 1) into power supplies needed by the signal generating device 110, the sensor unit 120 and the control unit 130. In this embodiment, the signal generating device 110 is implemented by an infrared emitter IR_E1, and the sensor unit 120 is capable of sensing at least infrared light. For example, the sensor unit 120 may include an infrared proximity sensor(s) (not shown in FIG. 1). The control unit 130 is coupled to the signal generating device 110, the sensor unit 120, the power supply circuit 140 and the light emitting unit 104, and is arranged to control the signal generating device 110, the sensor unit 120 and the light emitting unit 104. In addition, the control unit 130 may be a general purpose micro-processor, an application processor with the algorithm embedded, an application specific IC (ASIC) or a microcontroller (MCU). By taking an example where the sensor-controlled system 100 controls the electronic apparatus 102 by detecting the approaching and moving away of a person, the operation principle of the sensor-controlled system 100 will be described below.

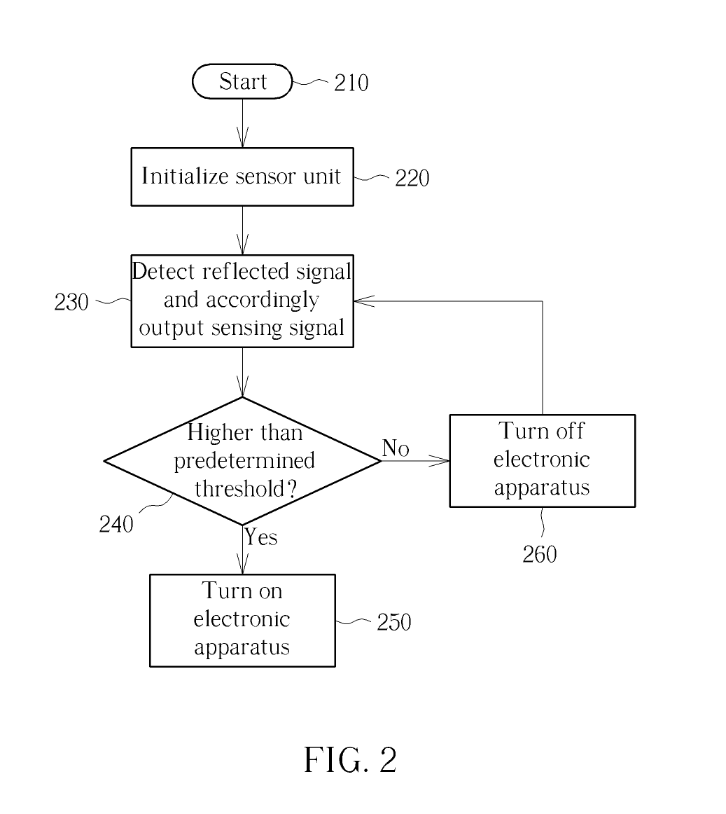

Please refer to FIG. 1 and FIG. 2 together. FIG. 2 is a flowchart of an exemplary sensor-controlled method for an electronic apparatus according to an embodiment of the present invention, wherein the exemplary method may be employed to control the electronic apparatus 102 shown in FIG. 1. Consider a case where the electronic apparatus 102 and the sensor-controlled system 100 are located in a room. In the beginning, the electronic apparatus 102 is turned off (i.e. the light emitting unit 104 operates at a non-emission state). After activating the sensor-controlled system 100 (step 210), the power supply circuit 140 may receive an input power (not shown in FIG. 1) to provide required powers for the signal generating device 110, the sensor unit 120 and the control unit 130, and the sensor unit 120 may be initialized (e.g. setting related sensing parameters) (step 220). When the control unit 130 activates the infrared emitter IR_E1, the infrared emitter IR_E1 may emit a detection signal S_I. When someone enters the room, the detection signal S_I may be reflected by the human body to generate a reflected signal S_R, and the sensor unit 120 may detect the reflected signal S_R and accordingly output a first sensing signal S_S1 to the control unit 130 (step 230).

Next, the control unit 130 may control the electronic apparatus 102 according to the first sensing signal S_S1. For example, the control unit 120 may compare signal intensity of the first sensing signal S_S1 with a predetermined threshold to generate a comparison result, and turn on or turn off the electronic apparatus 102 according to the comparison result (step 240). In this embodiment, when the distance between a person and the sensor-controlled system 100 is so short (e.g. the person has just entered the room) that the signal intensity of the first sensing signal S_S1 is higher than the predetermined threshold, the sensor-controlled system 100 may generate the driving signal S_D to the electronic apparatus 102 for enabling the lighting function thereof (step 250); otherwise, when the distance between the person and the sensor-controlled system 100 is not short enough (e.g. the person has not yet entered the room), the signal intensity of the first sensing signal S_S1 is lower than the predetermined threshold, and the control unit 130 does not turn on the electronic apparatus 102 (step 260) until the first sensing signal S_S1 received afterward is higher than the predetermined threshold.

When the person moves away from the room, the sensor-controlled system 100 may employ the aforementioned control mechanism to turn off the electronic apparatus 102. In brief, the sensor-controlled system 100 not only realizes a smart control mechanism but also achieves energy saving. It should be noted that the control operation of control unit 130 for the electronic apparatus 102 is not limited to turning on and turning off. For example, when a person enters the room, the sensor-controlled system 100 may enable the electronic apparatus 102 to provide incandescent light; and when the person leaves the room, the sensor-controlled system 100 may enable the electronic apparatus 102 to provide night light (e.g. yellow light).

Additionally, the signal generating device 110 is not limited to an infrared emitter or a light emitter. In one implementation, the detection signal S_I generated by the signal generating device 110 may be light having a different wavelength or an audio signal.

After turning on the electronic apparatus 102 (e.g. the LED lighting fixture), the sensor-controlled system 100 may also adjust brightness of the electronic apparatus 102 according to surrounding luminance (e.g. luminance of surrounding light L_SR). The following uses ambient light/visible light as the surrounding light L_SR to describe how the brightness of the electronic apparatus 102 is adjusted according to the surrounding luminance. However, a person skilled in the art should understand that the surrounding light L_SR may include light of other wavelengths.

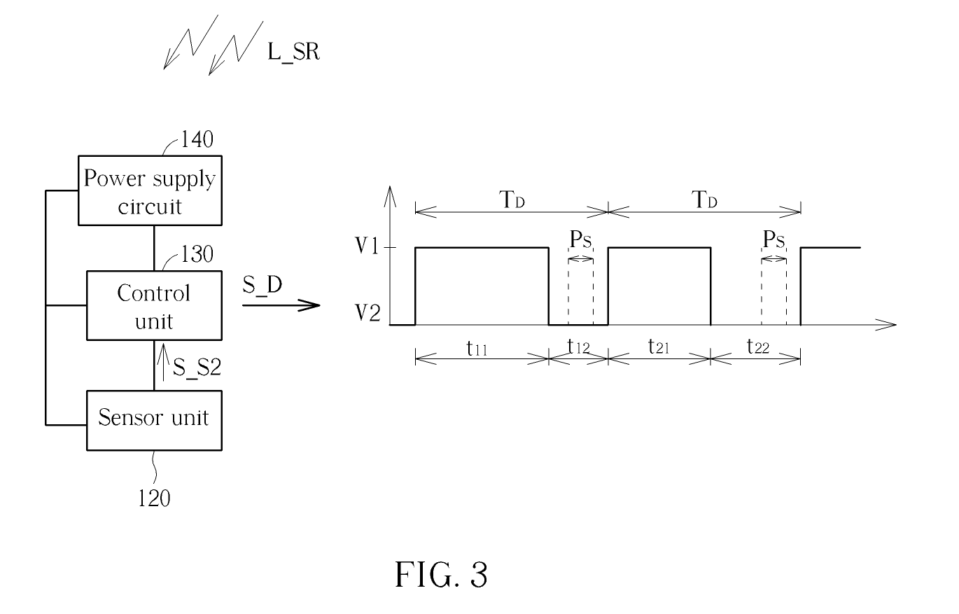

Please refer to FIG. 3 in conjunction with FIG. 1. FIG. 3 is a diagram illustrating an implementation of referring to the surrounding luminance (e.g. the luminance of the surrounding light L_SR) to adjust luminous intensity of the light emitting unit 104 shown in FIG. 1. After turning on the electronic apparatus 102, the driving signal S_D generated by the control unit 120 may control the light emitting unit 104 to operate at an emission state and a non-emission state alternately. In this implementation, the driving signal S_D has a first level V1 and a second level V2. When the driving signal S_D is at the first level V1, the driver 108 may turn on the LEDs D_1-D_N, which causes the light emitting 104 to operate at the emission state; when the driving signal S_D is at the second level V2, the LEDs D_1-D_N do not conduct, and the light emitting 104 operates at the non-emission state. Thus, by controlling a ratio between a time width of the first level V1 and a time width of the second level V2 in a driving cycle T_{D}, the control unit 130 may adjust the luminous intensity of the light emitting unit 104. The longer the time width of the first level V1, the higher the brightness of the emitting unit 104 perceived by the human eye. Please note that the control unit 130 may further control an emission cycle (e.g. the driving cycle T_{D}) of the light emitting unit 104 to be not larger than the persistence of vision time, and therefore the alternation of the emission and non-emission states may not be perceived by the human eye. For example, the control unit 130 may control an emission frequency of the light emitting unit 104 to be not less than 200 Hz.

In this implementation, the sensor unit 120 may further be capable of sensing ambient light (i.e. the surrounding light L_SR). For example, the sensor unit 120 may further include ambient light sensor(s) (not shown in FIG. 3). The sensor unit 120 may sense the ambient light to generate a second sensing signal S_S2 to the control unit 130, and the control unit 130 may control the luminous intensity of the light emitting unit 104 according to the second sensing signal S_S2. Please note that, in order to avoid sensing light generated by the light emitting unit 104 during sensing of the ambient light, the control unit 130 may control the sensor unit 120 to sense the ambient light (sensing time P_{S} is needed) during a period in which the light emitting unit 104 operates at the non-emission state (e.g. a second time width t₁₂ corresponding to the second level V2). Preferably, during the period in which the light emitting unit 104 operates at the emission state (e.g. a first time width t₁₁ corresponding to the first level V1), the sensor unit 120 may not generate the second sensing signal S_S2 to the control unit 130. In this way, the outputted second sensing signal S_S2 is mainly generated from the ambient light sensing.

After the sensor unit 120 outputs the second sensing signal S_S2 to the control unit 130 during the time width t₁₂, the control unit 130 may determine a waveform of the driving signal S_D of the next driving cycle, and adjust the luminous intensity of the light emitting unit 104 accordingly. In this implementation, due to the sufficient ambient light, the control unit 130 may decrease the brightness of the light emitting unit 104 by shortening the first time width t₁₁ to a first time width t₂₁ and extending the second time width t₁₂ to a second time width t₂₂. If the ambient light is sufficient, the light emitting unit 104 may even be adjusted to full dark (i.e. the first time width corresponding to the first level V1 is zero). In another implementation, if the ambient light is not sufficient, the first time width t₁₁ may be extended, and the second time width t₁₂ may be shortened, wherein the shortened second time width still covers the sensing time P_{S}.

In brief, as long as the sensing time P_{S} is included in the time width of the non-emission state, a ratio between the first time width (corresponding to the first level V1) and the second time width (corresponding to the second level V2), i.e. the duty cycle of the driving signal S_D, may be adjusted dynamically according to the surrounding light L_SR, thereby providing stable and comfortable brightness for the user.

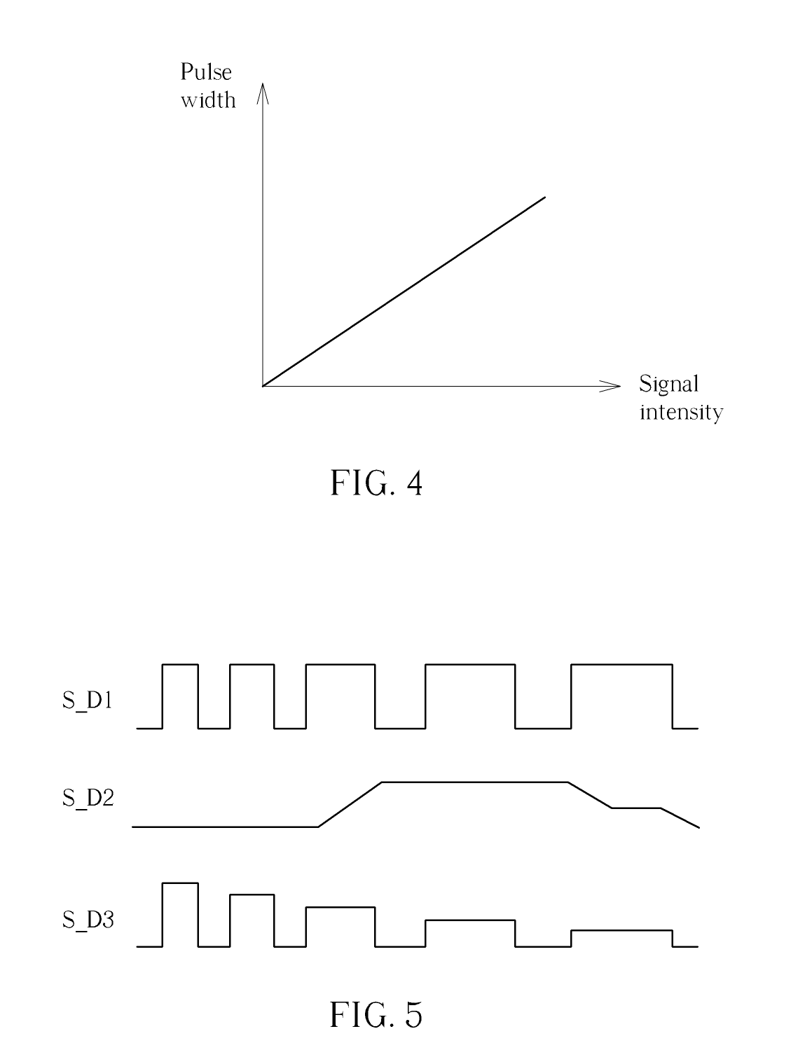

Please refer to FIG. 4, which is a diagram illustrating an implementation of a correspondence between a pulse width of the driving signal S_D (i.e. the first time width t₁₁/t₂₁) and signal intensity of the second sensing signal S_S2 shown in FIG. 3. As shown in FIG. 4, when receiving the second sensing signal S_S2, the control unit 130 may generate the driving signal S_D having a corresponding pulse width by directly referring to the correspondence between the pulse width and the signal intensity. In another implementation, the control unit 130 may calculate the pulse width of the following driving signal S_D while receiving the second sensing signal S_S2. It should be noted that waveform adjustment of the driving signal S_D is not limited to adjusting the first time width of the first level V1. That is, it is feasible to adjust the second time width of the second level V2 according to the second sensing signal S_S2, or to directly adjust the ratio between of the first time width and the second time width.

The aforementioned waveform of the driving signal S_D is for illustrative purposes only, and is not meant to be a limitation of the present invention. Please refer to FIG. 5, which is a waveform diagram illustrating implementations of the driving signal S_D of the present invention. When a pulse width modulation (PWM) signal (i.e. a driving signal S_D1) is used as a driving signal, the control unit 130 may adjust a pulse width of the driving signal according to the second sensing signal S_S2; when an amplitude modulation (AM) signal (i.e. a driving signal S_D2) is used as a driving signal, the control unit 130 may adjust an amplitude of the driving signal according to the second sensing signal S_S2; when a hybrid PWM/AM (HPWAM) signal (i.e. a driving signal S_D3) is used as a driving signal, the control unit 130 may adjust a pulse width and an amplitude of the driving signal according to the second sensing signal S_S2.

As light wavebands for detecting surrounding luminance and objects may be different, surrounding luminance detection and surrounding object detection may be performed separately or simultaneously by the sensor unit 120. Please refer to FIG. 3 again. In a case where the control unit 130 controls the sensor unit 120 to perform the surrounding luminance detection and the surrounding object detection simultaneously, the control unit 130 may activate the signal generating device 110 shown in FIG. 1 within the time width t₁₂. Hence, the sensor unit 120 may sense the surrounding light L_SR (e.g. the ambient light) and the reflected signal S_R shown in FIG. 1 (e.g. the infrared light) simultaneously during the sensing time P_{S}. Additionally, by performing the above detections while the light emitting unit 104 operates at the non-emission state, the sensor unit 120 may be disposed in an area disturbed by the LEDs D_1-D_N shown in FIG. 1.

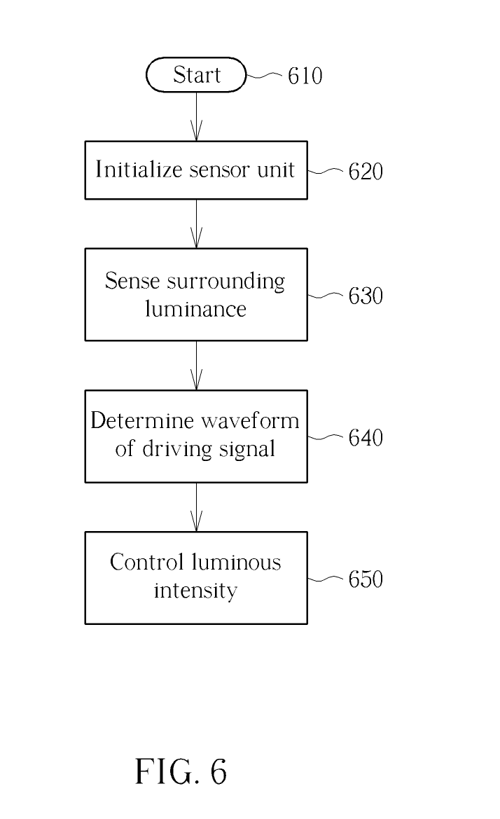

Please refer to FIG. 6, which is a flow chart illustrating an exemplary sensor-controlled method for an electronic apparatus according to another embodiment of the present invention. The electronic apparatus includes at least one light emitting unit, and the at least one light emitting unit operates at an emission state and a non-emission state alternately. The exemplary method may be employed to adjust the brightness of the electronic apparatus 102 shown in FIG. 1, and may be summarized as below.

Step 610: Start.

Step 620: Initialize a sensor unit for detecting surrounding light.

Step 630: During a period in which the at least one light emitting unit operates at the non-emission state, sense surrounding luminance (e.g. luminance of ambient light) to generate a sensing signal.

Step 640: Determine a waveform of a driving signal according to the sensing signal.

Step 650: Drive the at least one light emitting unit according to the driving signal, and accordingly control luminous intensity.

As a person skilled in the art should readily understand the operation of each step shown in FIG. 6 after reading the description directed to FIGS. 3-5, further description is omitted here for brevity.

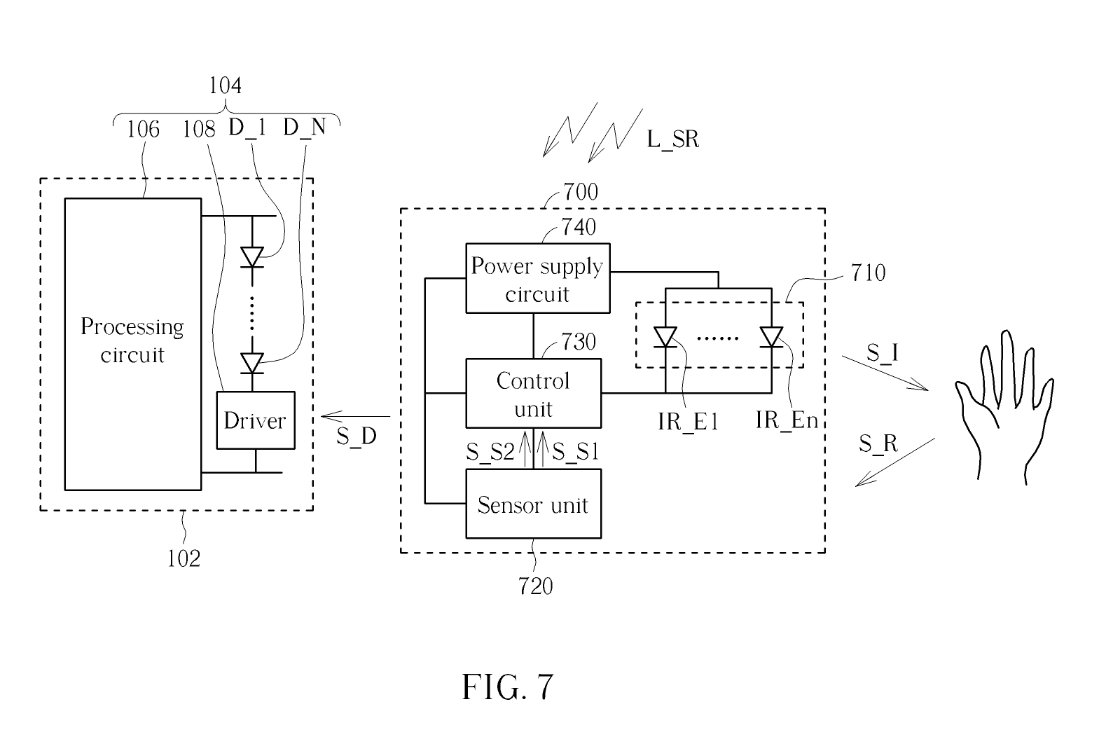

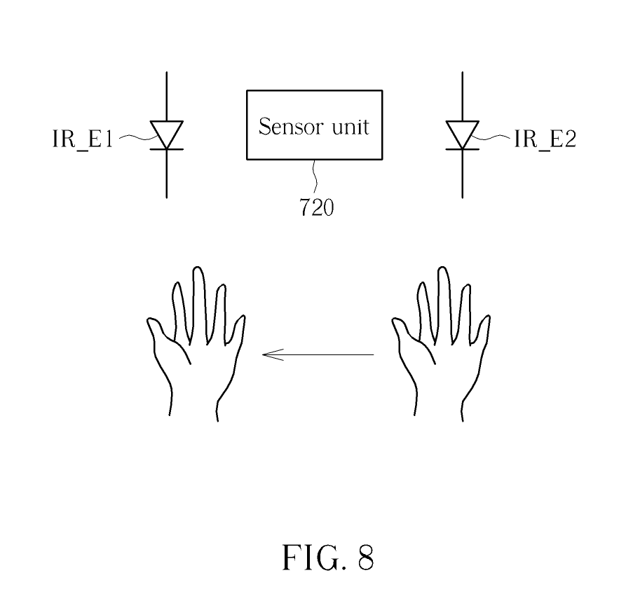

In addition to detect the approaching and moving away of an object to control an electronic apparatus, the proposed sensor-controlled system may employ a gesture control mechanism. Please refer to FIG. 7, which is a diagram illustrating an exemplary sensor-controlled system for an electronic apparatus according to another embodiment of the present invention. The architecture of the sensor-controlled system 700 is based on the architecture of the sensor-controlled system 100 shown in FIG. 1, wherein the main difference is that the signal generating device 710 of the sensor-controlled system 700 includes a plurality of infrared emitters IR_E1-IR_En. Please refer to FIG. 7 and FIG. 8 together. FIG. 8 is a diagram illustrating an implementation of disposition of the infrared emitters IR_E1-IR_En shown in FIG. 7. After the sensor-controlled system 700 is activated, the power supply circuit 740 may supply powers required by the signal generating device 710, the sensor unit 720 and the control unit 730. The control unit 730 may activate the infrared emitters IR_E1-IR_En one at a time according to an activation sequence so that only one infrared emitter is activated at a time. As shown in FIG. 8, the control unit 730 may activate the infrared emitter IR_E1 for emitting a detection signal during a first period of time. After deactivating the infrared emitter IR_E1, the control unit 730 may activate the infrared emitter IR_E2 to emit a detection signal, and then deactivate the infrared emitter IR_E2. During a second period of time (following the first period of time), the control unit 730 may repeat the activation and deactivation performed during the first period of time. In brief, the control unit 730 may activate the infrared emitters IR_E1-IR_En one at a time in a time-division multiplexing (TDM) manner.

By using the TDM activation scheme, the sensor unit 720 may detect the reflected signal S_R reflected from an object (i.e. a hand) according to the activation sequence, and accordingly output the first sensing signal S_S1 (i.e. a proximity sensing signal), wherein the control unit 730 may perform gesture recognition according to the first sensing signal S_S1. As shown in FIG. 8, for example, the user's hand may move from the infrared emitter IR_E2 (during the first period of time) to the infrared emitter IR_E1 (during the second period of time). During the first period of time, when the infrared emitter IR_E1 is activated (e.g. at a first time point), the sensor unit 720 may not detect a reflected signal corresponding to the infrared emitter IR_E1 due to the distance; when the infrared emitter IR_E2 is activated (e.g. at a second time point following the first time point), the sensor unit 720 may detect a reflected signal corresponding to the infrared emitter IR_E2. Similarly, during the second period of time, the sensor unit 720 may detect a reflected signal corresponding to the infrared emitter IR_E1 rather than the infrared emitter IR_E2. Hence, the control unit 730 may recognize a “moving from right to left” gesture according to the corresponding first sensing signal S_S1.

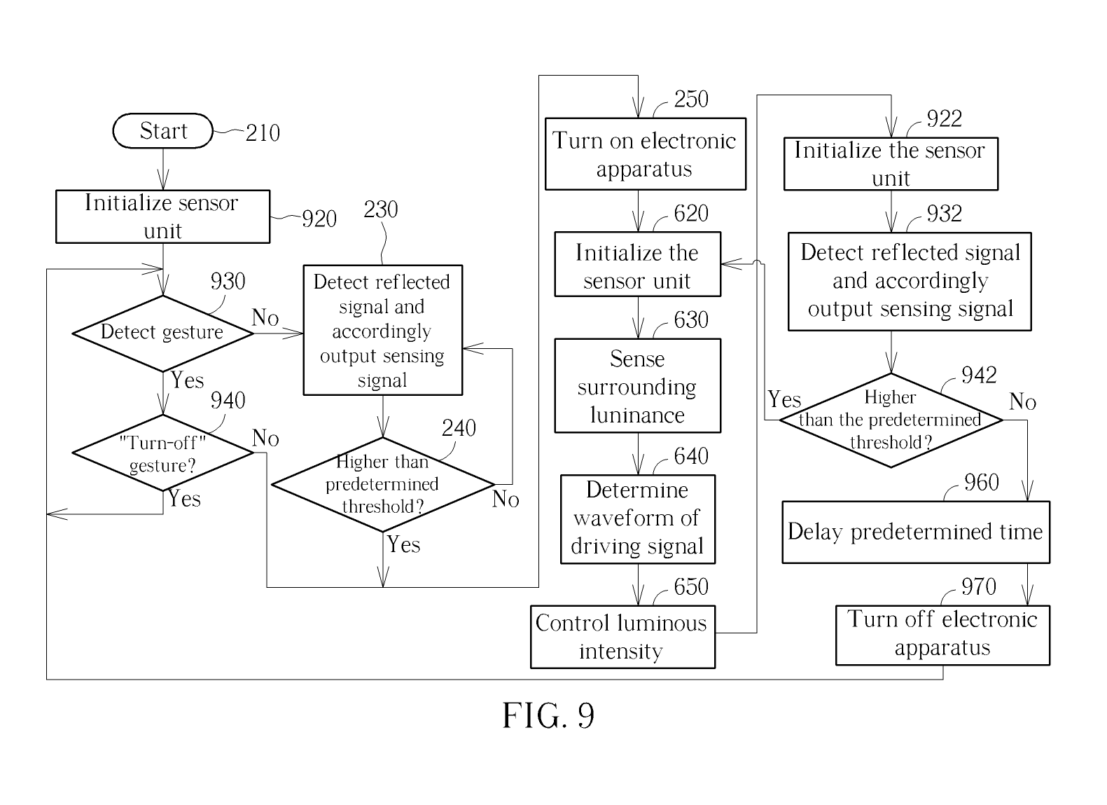

As the sensor-controlled system 700 may perform gesture recognition, the control unit 730 may control the operation (e.g. turning-on or turning-off) of the electronic apparatus 102 according to the first sensing signal S_S1. Please refer to FIG. 9, which is a flow chart illustrating an exemplary sensor-controlled method for the electronic apparatus 102 shown in FIG. 7 according to an embodiment of the present invention. The exemplary method is based on the methods shown in FIG. 2 and FIG. 6, and further includes the steps of gesture recognition, proximity sensing and ambient light sensing. The exemplary method may be summarized as below.

Step 210: Start.

Step 920: Initialize the sensor unit 720 for proximity sensing and gesture recognition.

Step 930: When the infrared emitters IR_E1-IR_En are activated one at a time according to an activation sequence, detect the reflected signal S_R reflected from the hand according to the activation sequence, output the first sensing signal S_S1 accordingly, and proceed to step 940; when the infrared emitters IR_E1-IR_En are not activated one at a time according to the activation sequence, go to step 230.

Step 940: Recognize if the first sensing signal S_S1 corresponds to a “turn-off” gesture. If yes, return to step 930; otherwise, proceed to step 250.

Step 230: Detect the reflected signal S_R corresponding to the detection signal S_I, and accordingly output the first sensing signal S_S1.

Step 240: Compare the signal intensity of the first sensing signal S_S1 with a predetermined threshold. If the signal intensity of the first sensing signal S_S1 is greater than the predetermined threshold, go to step 250; otherwise, return to step 230.

Step 250: Turn on the electronic apparatus 102.

Step 620: Initialize the sensor unit 720 for surrounding light detection.

Step 630: During a period in which the light emitting unit 104 operates at the non-emission state, sense surrounding luminance (e.g. luminance of the surrounding light L_SR) to generate the second sensing signal S_S2.

Step 640: Determine a waveform of the driving signal S_D according to the second sensing signal S_S2.

Step 650: Drive the light emitting unit 104 according to the driving signal S_D, and accordingly control the luminous intensity thereof.

Step 922: Initialize the sensor unit 720 for proximity sensing.

Step 932: Detect the reflected signal S_R corresponding to the detection signal S_I, and accordingly output the first sensing signal S_S1.

Step 942: Compare the signal intensity of the first sensing signal S_S1 with the predetermined threshold. If the signal intensity of the first sensing signal S_S1 is greater than the predetermined threshold, go to step 630; otherwise, return to step 960.

Step 960: Delay a predetermined time to finish ongoing brightness adjustment.

Step 970: Turn off the electronic apparatus 102.

During a specific period of time, the sensor-controlled system 700 may execute steps 930, 940, 230 and 240 repeatedly. The sensor-controlled system 700 may integrate the received first sensing signal S_S1 over time to enhance the detection accuracy, and accordingly determine whether the electronic apparatus 102 should be turned on, and then activate the brightness adjustment mechanism. During another specific period of time, the sensor-controlled system 700 may execute steps 250, 620, 630, 640, 650, 922, 932, 942, 960 and 970 repeatedly. The sensor-controlled system 700 may integrate the received first sensing signal S_S1 and second sensing signal S_S2 over time to enhance the detection accuracy, and accordingly adjust the luminous intensity of the light emitting unit 104 and determine whether the electronic apparatus 102 should be kept turned on. Although the flow shown in FIG. 9 performs the gesture recognition prior to the proximity sensing, it is feasible to perform the proximity sensing prior to the gesture recognition, or to perform the proximity sensing and the gesture recognition in parallel. As a person skilled in the art can readily understand the operation of each step shown in FIG. 9 after reading the description directed to FIGS. 1-8, further description is omitted here for brevity.

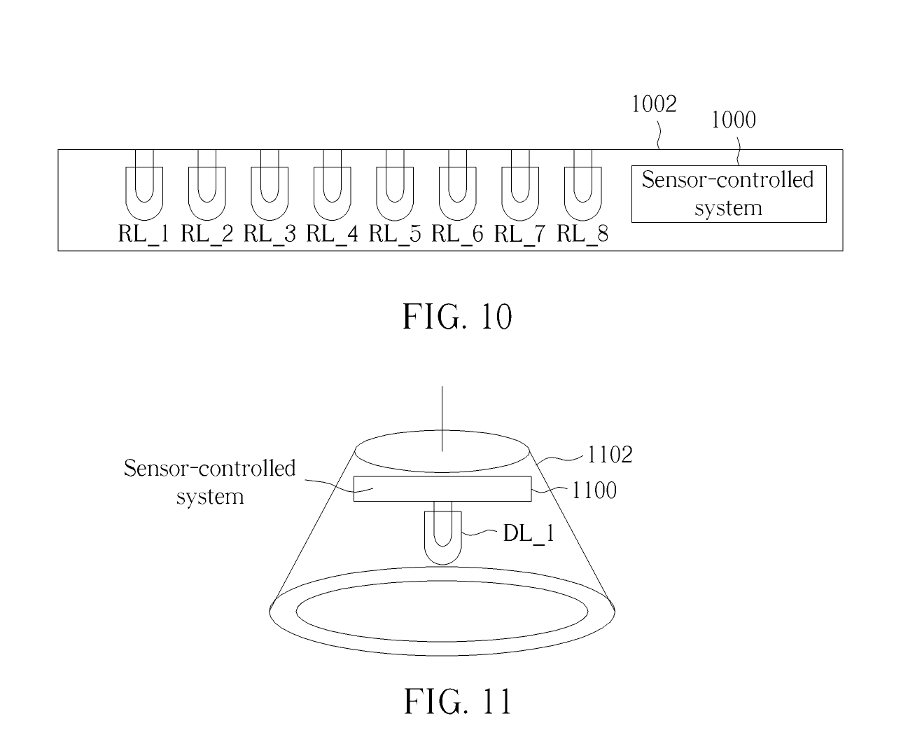

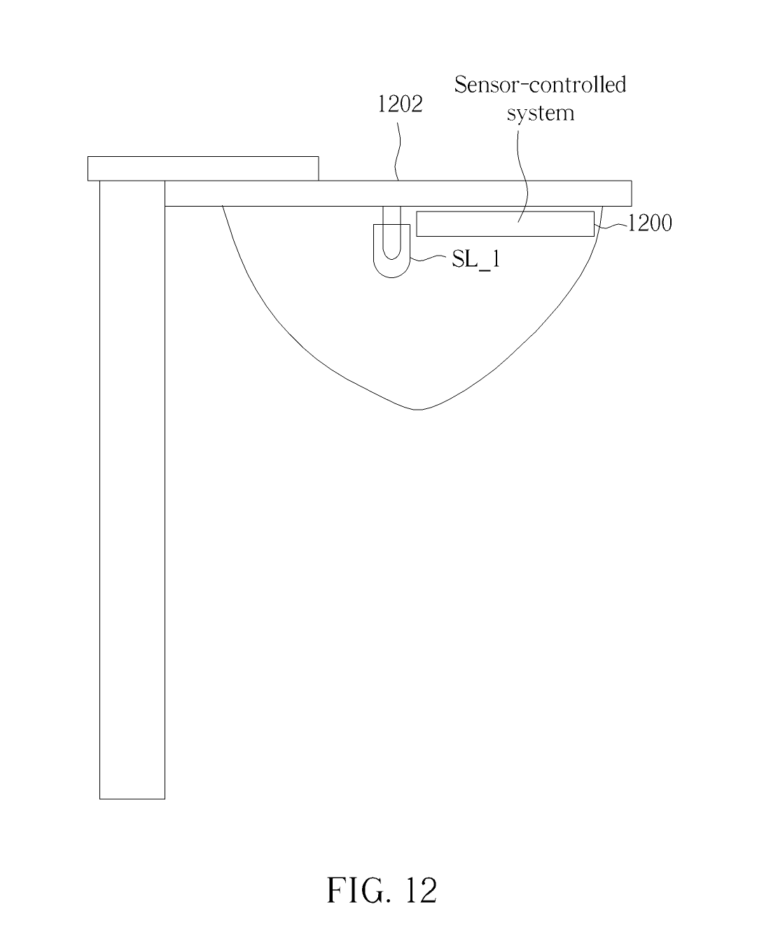

As mentioned above, the proposed sensor unit may perform the sensing operation during a period in which the electronic apparatus operates at the non-emission state. Therefore, the proposed sensor-controlled system and the light emitting unit may be disposed in the same area, and accuracy of surrounding luminance sensing will not be affected. Please refer to FIGS. 10-12 together. Each figure is a diagram illustrating an exemplary disposition of a sensor-controlled system and an electronic apparatus according to an embodiment of the present invention. As shown in FIGS. 10-12, a sensor-controlled system 1000 may be installed near (or next to) a plurality of light bulbs RL_1-RL_8 in a room light 1002, a sensor-controlled system 1100 may be installed near (or next to) a bulbs DL_1 in a table (or desk) light 1102, and a sensor-controlled system 1200 may be installed near (or next to) a bulb SL_1 in a street light 1202. In brief, the proposed sensor-controlled system may be hidden from the exterior design of the electronic apparatus, and can be widely used in a variety of applications.

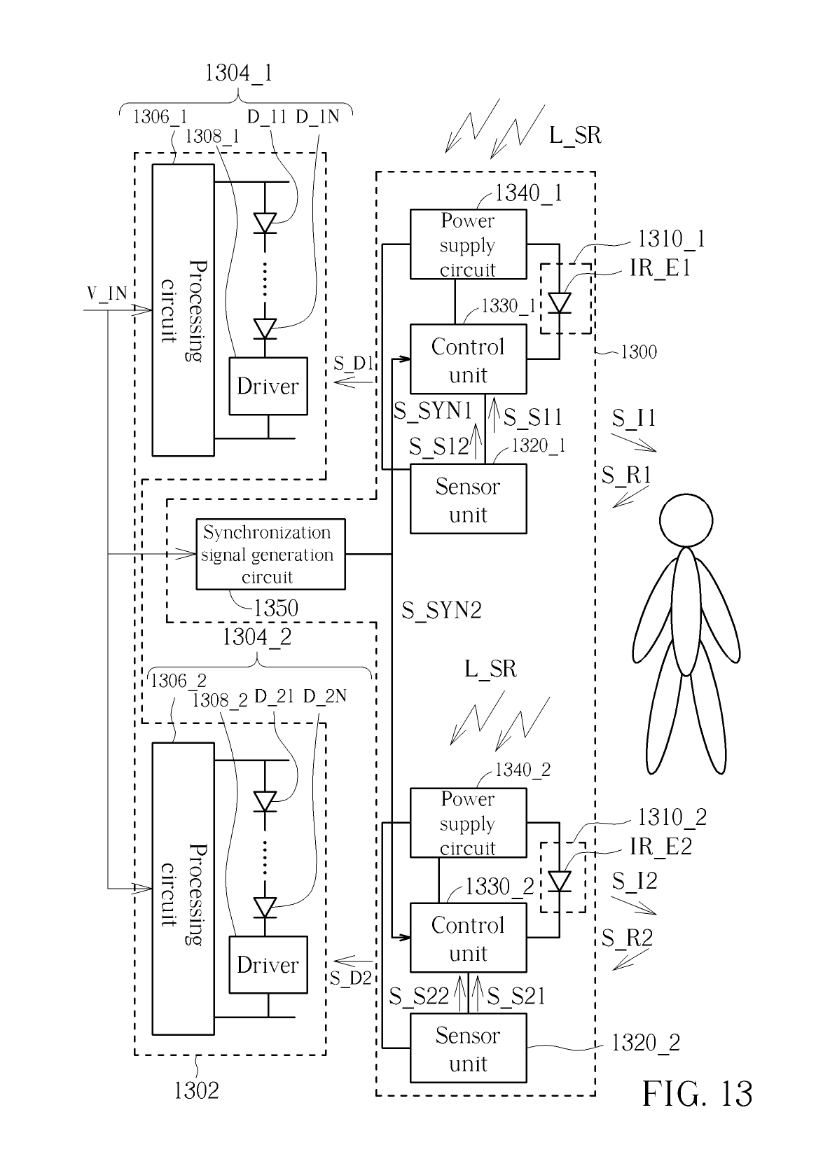

Please note that the electronic apparatus 1002 has multiple light bulbs RL_1-RL_8. As one of the light bulbs RL_1-RL_8 may be disturbed by light emitted from other light bulbs during the sensing operation (i.e. the light bulbs RL_1-RL_8 emit light asynchronously), the proposed sensor-controlled system may further include a synchronization signal generation circuit to solve the problem. Please refer to FIG. 13, which is a diagram illustrating an exemplary sensor-controlled system for an electronic apparatus according to another embodiment of the present invention. The architecture of the sensor-controlled system 1300 is based on the architecture of the sensor-controlled system 100 shown in FIG. 1, wherein the main difference is that the sensor-controlled system 1300 includes signal generating devices 1310_1 and 1310_2, sensor units 1320_1 and 1320_2, control units 1330_1 and 1330_2, power supply circuits 1340_1 and 1340_2, and a synchronization signal generation circuit 1350. The signal generating devices 1310_1 and 1310_2 are implemented by infrared emitters IR_E1 and IR_E2, respectively. The control units 1330_1 and 1330_2 are arranged to control a plurality of light emitting units 1304_1 and 1304_2 included in an electronic apparatus 1302, respectively. The light emitting units 1304_1 and 1304_2 include a plurality of LEDs D_11-D_1N and D_21-D_2N, processing circuits 1306_1 and 1306_2, and drivers 1308_1 and 1308_2, respectively. As a person skilled in the art can readily understand generation and use of detection signals S_11 and S_12, reflected signals S_R1 and S_R2, first sensing signals S_S11 and S_S21, second sensing signals S_S12 and S_S22, and driving signals S_D1 and S_D2, further description is omitted here for brevity.

The synchronization signal generation circuit 1350 is coupled to the control units 1330_1 and 1330_2, and is arranged to generate synchronization signals S_SYN1 and S_SYN2 according to an input power V_IN, wherein the input power V_IN is also an input power of the processing circuits 1306_1 and 1306_2. The control units 1330_1 and 1330_2 may generate the driving signals S_D1 and S_D2 according to the synchronization signals S_SYN1 and S_SYN2, and accordingly control the corresponding light emitting units 1304_1 and 1304_2 to turn off simultaneously (i.e. at the non-emission state). During a period in which both of the light emitting units 1304_1 and 1304_2 operate at the non-emission state, both of the control units 1330_1 and 1330_2 may control the corresponding sensing units to sense the surrounding luminance (e.g. the luminance of the surrounding light L_SR), thereby adjusting brightness of the corresponding light emitting units 1304_1 and 1304_2.

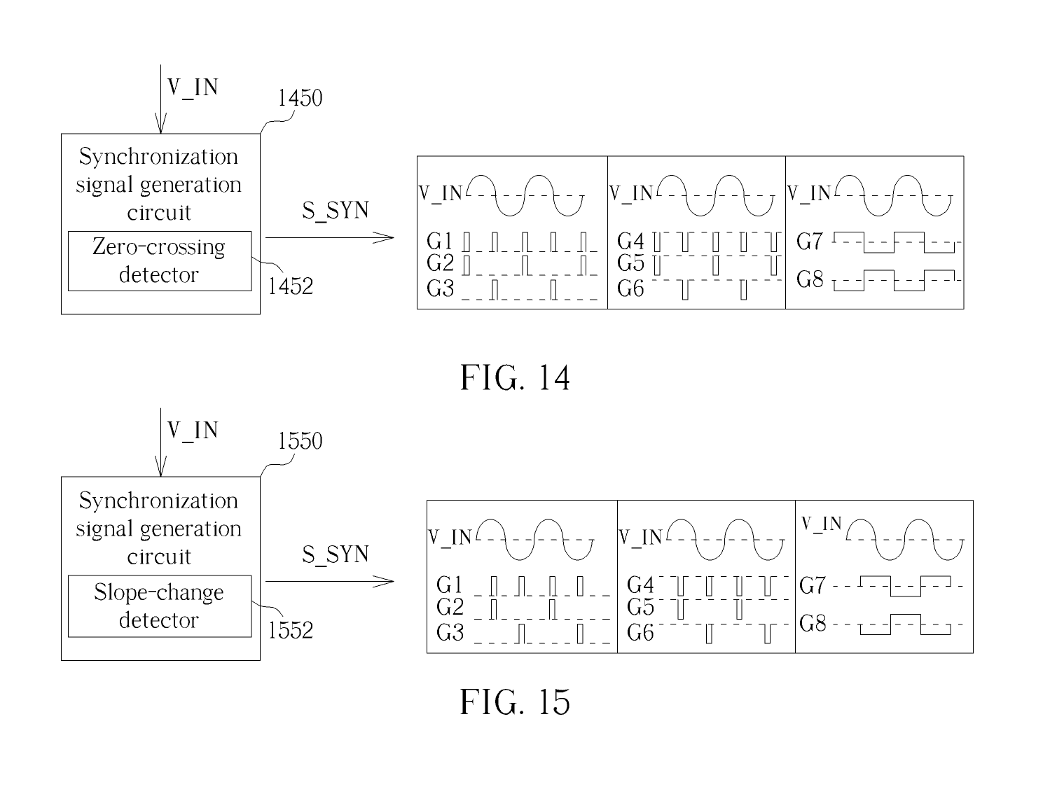

Please refer to FIG. 14, which is a diagram illustrating an exemplary signal generation mechanism of a synchronization signal generation circuit according to an embodiment of the present invention. The synchronization signal generation circuit 1450 includes a zero-crossing detector 1452. By utilizing the zero-crossing detector 1452 to detect a time point (i.e. a zero-crossing point) at which the input power V_IN crosses the zero axis, the synchronization signal generation circuit 1450 may generate a synchronization signal S_SYN. In one implementation, each time a voltage of the input power V_IN equals zero, the synchronization signal generation circuit 1450 may generate a synchronization signal G1 (having a positive voltage); in another implementation, each time a voltage of the input power V_IN passes through the zero axis from the negative to the positive, the synchronization signal generation circuit 1450 may generate a synchronization signal G2 (having a positive voltage); in yet another implementation, each time a voltage of the input power V_IN passes through the zero axis from the positive to the negative, the synchronization signal generation circuit 1450 may generate a synchronization signal G3 (having a positive voltage). Synchronization signals G4-G6 are generated based on generation mechanisms of the synchronization signals G1-G3, respectively, wherein the difference is that the synchronization signals G4-G6 have negative voltages. Additionally, the synchronization signal generation circuit 1450 may change polarity of a synchronization signal (e.g. synchronization signals G7 and G8) at a zero-crossing point.

Please refer to FIG. 15, which is a diagram illustrating an exemplary signal generation mechanism of a synchronization signal generation circuit according to another embodiment of the present invention. The synchronization signal generation circuit 1550 includes a slope-change detector 1552. By utilizing the slope-change detector 1552 to detect a time point at which a voltage slope of the input power V_IN changes polarity, the synchronization signal generation circuit 1550 may generate a synchronization signal S_SYN. In one implementation, each time the voltage slope of the input power V_IN changes polarity, the synchronization signal generation circuit 1550 may generate a synchronization signal G1 (having a positive voltage); in another implementation, each time the voltage slope of the input power V_IN changes the polarity from positive to negative, the synchronization signal generation circuit 1550 may generate a synchronization signal G2 (having a positive voltage); in yet another implementation, each time the voltage slope of the input power V_IN changes the polarity from negative to positive, the synchronization signal generation circuit 1450 may generate a synchronization signal G3 (having a positive voltage). Synchronization signals G4-G6 are generated based on generation mechanisms of the synchronization signals G1-G3, respectively, wherein the difference is that the synchronization signals G4-G6 have negative voltages. Additionally, the synchronization signal generation circuit 1550 may change polarity of a synchronization signal (e.g. synchronization signals G7 and G8) while the voltage slope of the input power V_IN changes the polarity.

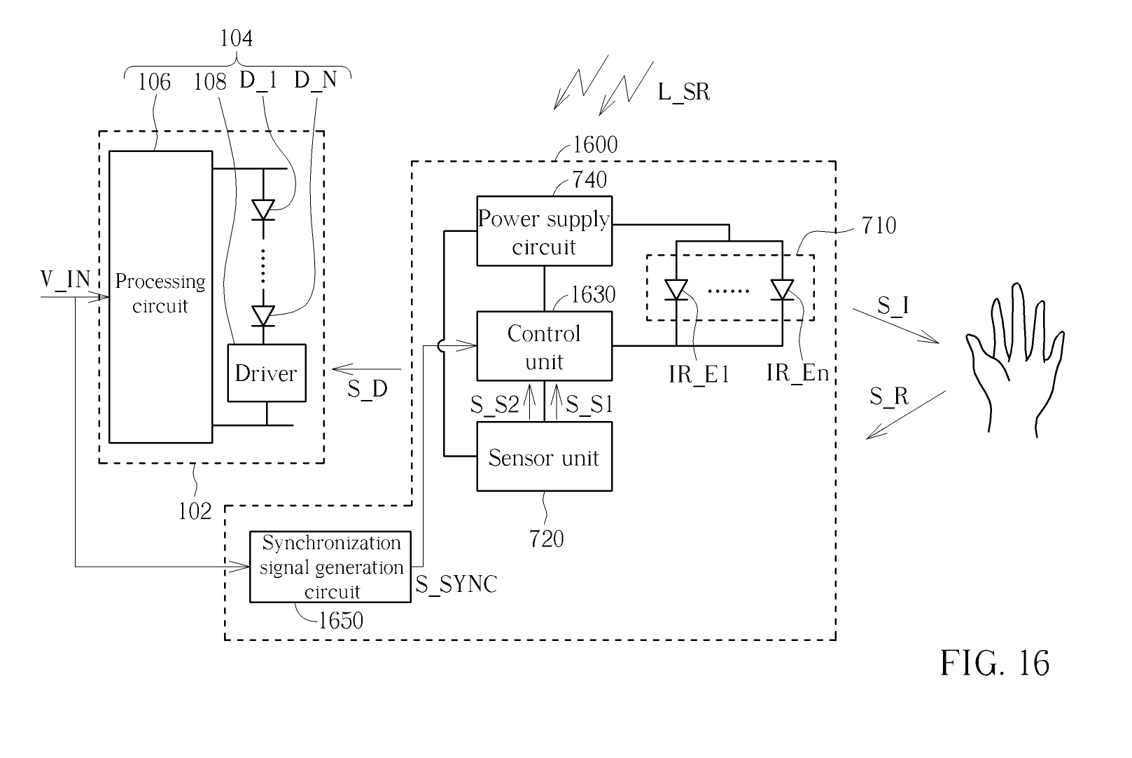

The concept of the synchronization signal may be employed to a sensor-controlled system capable of gesture recognition. Please refer to FIG. 16, which is a diagram illustrating an exemplary sensor-controlled system for an electronic apparatus according to another embodiment of the present invention. The architecture of the sensor-controlled system 1600 is based on the architectures of the sensor-controlled systems shown in FIG. 7 and FIG. 13. The sensor-controlled system 1600 includes a synchronization signal generation circuit 1650, which generates a synchronization signal S_SYN to a control unit 1630. For clarity and brevity, only a single control unit and related circuit elements are illustrated in FIG. 16. A person skilled in the art should understand that the sensor-controlled system 1600 may include a plurality of control units and related circuit elements, wherein the control units are arranged to control a plurality of light emitting units (not shown in FIG. 16) included in the electronic apparatus 102. In addition, as a person skilled in the art should readily understand the operation of the sensor-controlled system 1600 after reading description directed to FIGS. 1-15, further description is omitted here for brevity.

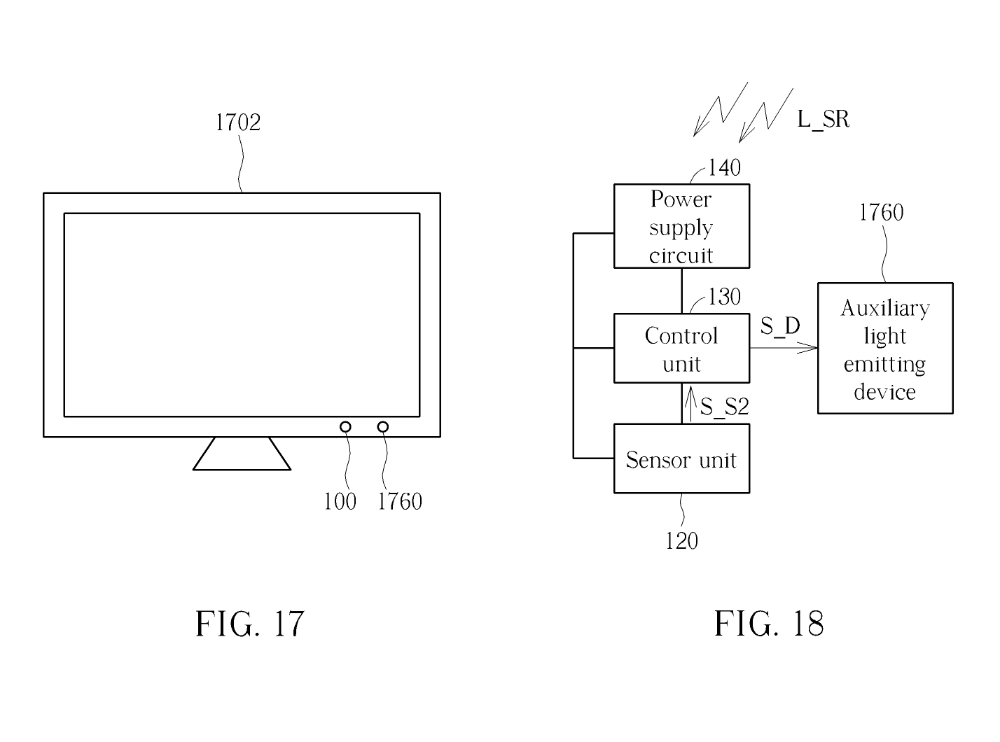

The electronic apparatus controlled by the proposed sensor-controlled system is not limited to a lighting fixture. For example, the electronic apparatus 102 shown in FIG. 1 may be an electrical or electronic product, such as a television, a computer or audio equipment. By using the proposed sensor-controlled system, the electrical or electronic product may be turned on and turned off in a sensor-controlled manner. In one embodiment where the electronic apparatus 102 is a television, the light emitting unit 104 shown in FIG. 1 may be regarded as a backlight module providing a light source. An ordinary electrical or electronic product may have light emitting devices disposed in different areas, however, which may affect the sensor-controlled operation. Please refer to FIG. 17, which is a diagram illustrating an exemplary television having the sensor-controlled system 100 shown in FIG. 1 according to an embodiment of the present invention. In this embodiment, the sensor-controlled system 100 is disposed near an auxiliary light emitting device 1760 (i.e. a power indicator) of the television 1702. As the auxiliary light emitting device 1760 may emit light during turn-on and turn-off periods of the television 1702 (e.g. emitting green light during the turn-on period, and emitting red light during the turn-off period), the sensor-controlled system 100 may be disturbed.

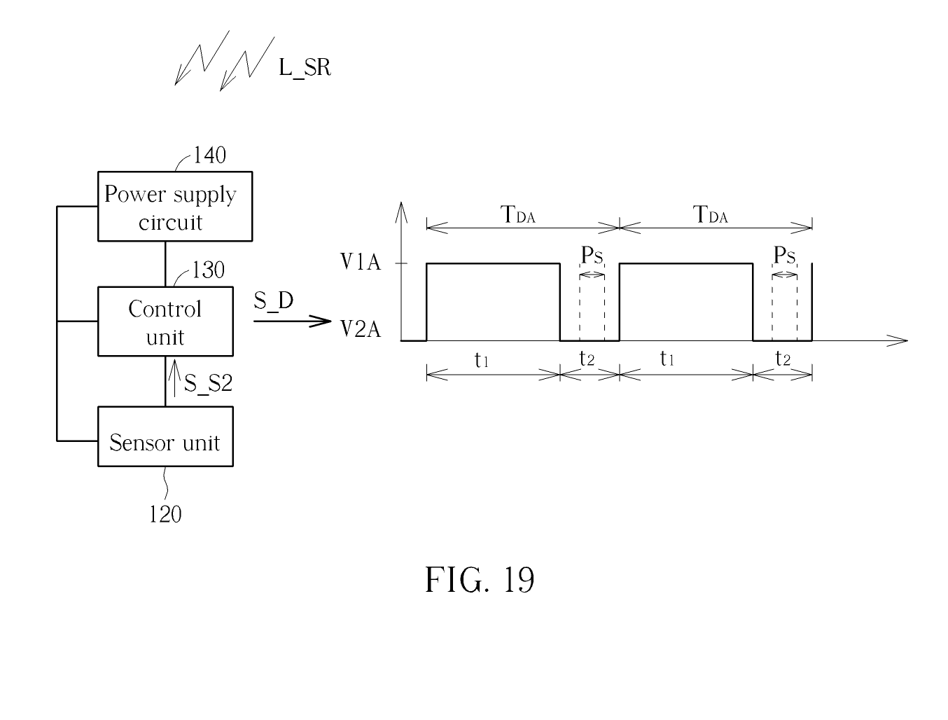

Please refer to FIG. 18 and FIG. 19 together. FIG. 18 is a block diagram illustrating an exemplary sensor-controlled system for controlling the auxiliary light emitting device 1760 shown in FIG. 17 according to an embodiment of the present invention. FIG. 19 is a diagram illustrating an implementation of an operation state of the auxiliary light emitting device 1760 shown in FIG. 17 controlled by the sensor-controlled system shown in FIG. 18. In this embodiment, the control unit 130 may generate a driving signal S_DA to control the operation state of the auxiliary light emitting device 1760. During a period (i.e. the sensing time P_{S}) in which the sensor unit 120 senses the surrounding luminance (e.g. the luminance of the surrounding light L_SR), the driving signal S_DA may enable the auxiliary light emitting device 1760 to turn off, thereby avoiding/reducing disturbances (from the auxiliary light emitting device 1760) in the second sensing signal S_S2 generated by the sensor unit 120. In this embodiment, the driving cycle T_{DA} of the driving signal S_DA may be shorter than the persistence of vision time (e.g. an emission frequency of the auxiliary light emitting device 1760 is not less than 200 Hz). Additionally, a ratio between a time width t₁ of a first level VIA and a time width t₂ of a second level V2A may be fixed to simplify the circuit design.

To sum up, the proposed sensor-controlled system may be installed in an electronic apparatus. The proposed sensor-controlled system controls a light-dark period of a light emitting unit of the electronic apparatus to lie within persistence of vision time. During a period in which the light emitting unit of the electronic apparatus is at a non-emission state, the proposed sensor-controlled system detects reflected signals, recognizes gestures and/or detects variations of surrounding light by sensors (e.g. a proximity sensor, a proximity gesture sensor and an ambient light sensor). In this way, a highly accurate sensing operation as well as a smart control system can be realized, and no flickering will be perceived during a brightness adjustment process. Therefore, the energy efficiency of the electronic apparatus can be enhanced further, and a user-friendly and convenient user experience is provided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensor-controlled system for an electronic apparatus, comprising:
at least one signal generating device;
at least one sensor unit, for sensing a reflected signal reflected from an object when the at least one signal generating device is activated, and accordingly outputting a first sensing signal; and
at least one control unit, coupled to the at least one signal generating device and the at least one sensor unit, for controlling the electronic apparatus according to the first sensing signal.

2. The sensor-controlled system of claim 1, wherein the at least one control unit compares signal intensity of the first sensing signal with a predetermined threshold to generate a comparison result, and turns on or turns off the electronic apparatus according to the comparison result.

3. The sensor-controlled system of claim 1, wherein the at least one signal generating device comprises a plurality of signal generating devices; the at least one control unit activates the signal generating devices one at a time according to an activation sequence so that only one signal generating device is activated at a time; and the at least one sensor unit detects the reflected signal reflected from the object according to the activation sequence, and outputs the first sensing signal accordingly.

4. The sensor-controlled system of claim 1, wherein the at least one control unit is coupled to at least one light emitting unit of the electronic apparatus; the at least one light emitting unit operates at an emission state and a non-emission state alternately; and after the at least one control unit activates the electronic apparatus, the at least one sensor unit further senses surrounding luminance to generate a second sensing signal to the at least one control unit during a period in which the at least one light emitting unit operates at the non-emission state, and the at least one control unit further controls luminous intensity of the at least one light emitting unit according to the second sensing signal.

5. The sensor-controlled system of claim 4, wherein the at least one control unit further controls an emission frequency of the at least one light emitting unit to be not less than 200 Hz.

6. The sensor-controlled system of claim 4, wherein during a period in which the at least one light emitting unit operates at the emission state, the sensor unit does not generate the second sensing signal to the at least one control unit.

7. The sensor-controlled system of claim 4, wherein during the period in which the at least one light emitting unit operates at the non-emission state, the at least one control unit further activates the at least one signal generating device; and when the at least one signal generating device is activated, the at least one sensor unit senses the reflected signal reflected from the object to output the first sensing signal.

8. The sensor-controlled system of claim 4, wherein the at least one control unit determines a waveform of a driving signal according to the second sensing signal, and controls the luminous intensity of the at least one light emitting unit according to the driving signal.

9. The sensor-controlled system of claim 8, wherein the driving signal is a pulse width modulation signal, an amplitude modulation signal or a hybrid pulse width modulation/amplitude modulation signal.

10. The sensor-controlled system of claim 4, wherein the at least one light emitting unit comprises a plurality of light emitting units, the at least one sensor unit comprises a plurality of sensor units, the at least one control unit comprises a plurality of control units, each of the control unit controls the corresponding light emitting unit and sensor unit, and the sensor-controlled system further comprises:
a synchronization signal generation circuit, coupled to the control units, for enabling the light emitting units to operate at the non-emission state simultaneously, wherein during a period in which each of the light emitting units operates at the non-emission state, each of the control units controls the corresponding sensor unit to sense the surrounding luminance.

11. The sensor-controlled system of claim 4, wherein the at least one control unit is further coupled to an auxiliary light emitting device of the electronic apparatus, and during a period in which the at least one sensor unit senses the surrounding luminance, the at least one control unit controls the auxiliary light emitting device to operate at a non-emission state.

12. A sensor-controlled system for an electronic apparatus, the electronic apparatus comprising at least one light emitting unit, the at least one light emitting unit operating at an emission state and a non-emission state alternately, the sensor-controlled system comprising:
at least one sensor unit, for sensing surrounding luminance to generate a sensing signal during a period in which the at least one light emitting unit operates at the non-emission state; and
at least one control unit, coupled to the at least one sensor unit, for controlling luminous intensity of the at least one light emitting unit according to the sensing signal.

13. The sensor-controlled system of claim 12, wherein the at least one control unit further controls an emission frequency of the at least one light emitting unit to be not less than 200 Hz.

14. The sensor-controlled system of claim 12, wherein during a period in which the at least one light emitting unit operates at the emission state, the sensor unit does not generate the sensing signal to the at least one control unit.

15. The sensor-controlled system of claim 12, wherein the at least one control unit determines a waveform of a driving signal according to the sensing signal, and controls the luminous intensity of the at least one light emitting unit according to the driving signal.

16. The sensor-controlled system of claim 15, wherein the driving signal is a pulse width modulation signal, an amplitude modulation signal or a hybrid pulse width modulation/amplitude modulation signal.

17. The sensor-controlled system of claim 15, wherein the driving signal has a first level and a second level; the first level and the second level correspond to a first time width and a second time width in a driving cycle, respectively; and the at least one control unit adjusts a ratio between the first time width and the second time width according to the sensing signal.

18. The sensor-controlled system of claim 12, wherein the at least one light emitting unit comprises a plurality of light emitting units, the at least one sensor unit comprises a plurality of sensor units, the at least one control unit comprises a plurality of control units, each of the control unit controls the corresponding light emitting unit and sensor unit, and the sensor-controlled system further comprises:
a synchronization signal generation circuit, coupled to the control units, for enabling the light emitting units to operate at the non-emission state simultaneously, wherein during a period in which each of the light emitting units operates at the non-emission state, each of the control units controls the corresponding sensor unit to sense the surrounding luminance.

19. The sensor-controlled system of claim 12, wherein the at least one control unit is further coupled to an auxiliary light emitting device of the electronic apparatus, and during a period in which the at least one sensor unit senses the surrounding luminance, the at least one control unit controls the auxiliary light emitting device to operate at a non-emission state.

20. A sensor-controlled method for an electronic apparatus, comprising:
activating at least one signal generating device to generate a detection signal;
when the at least one signal generating device is activated, detecting the detection signal which has been reflected, and referring to the reflected detection signal to output a first sensing signal; and
controlling the electronic apparatus according to the first sensing signal.

21. The sensor-controlled method of claim 20, wherein the step of controlling the electronic apparatus according to the first sensing signal comprises:
comparing signal intensity of the first sensing signal with a predetermined threshold to generate a comparison result; and
turning on or turning off the electronic apparatus according to the comparison result.

22. The sensor-controlled method of claim 20, wherein the at least one signal generating device comprises a plurality of signal generating devices, and the step of activating the at least one signal generating device to generate the detection signal comprises:
activating the signal generating devices one at a time according to an activation sequence;
wherein only one signal generating device is activated at a time.

23. The sensor-controlled method of claim 22, wherein the step of detecting the detection signal which has been reflected comprises:
detecting the reflected detection signal according to the activation sequence.

24. The sensor-controlled method of claim 20, wherein the electronic apparatus comprises at least one light emitting unit, the at least one light emitting unit operates at an emission state and a non-emission state alternately, and the sensor-controlled method further comprises:
after the electronic apparatus is activated, sensing surrounding luminance to generate a second sensing signal during the period in which the at least one light emitting unit operates at the non-emission state; and
controlling luminous intensity of the at least one light emitting unit according to the second sensing signal.

25. The sensor-controlled method of claim 24, wherein an emission frequency of the at least one light emitting unit is not less than 200 Hz.

26. The sensor-controlled method of claim 24, wherein during a period in which the at least one light emitting unit operates at the emission state, the step of sensing the surrounding luminance to generate the second sensing signal is not performed.

27. A sensor-controlled method for an electronic apparatus, the electronic apparatus comprising at least one light emitting unit, the at least one light emitting unit operating at an emission state and a non-emission state alternately, the sensor-controlled method comprising:
sensing surrounding luminance to generate a sensing signal during a period in which the at least one light emitting unit operates at the non-emission state; and
controlling luminous intensity of the at least one light emitting unit according to the sensing signal.

28. The sensor-controlled method of claim 27, wherein an emission frequency of the at least one light emitting unit is not less than 200 Hz.

29. The sensor-controlled method of claim 27, wherein during a period in which the at least one light emitting unit operates at the emission state, the step of sensing the surrounding luminance to generate the second sensing signal is not performed.

30. The sensor-controlled method of claim 27, wherein the step of controlling the luminous intensity of the at least one light emitting unit according to the sensing signal comprises:
determining a waveform of a driving signal according to the sensing signal, and controlling the luminous intensity of the at least one light emitting unit according to the driving signal.

31. The sensor-controlled method of claim 30, wherein the driving signal has a first level and a second level; the first level and the second level correspond to a first time width and a second time width in a driving cycle, respectively; and the step of determining the waveform of the driving signal according to the sensing signal comprises:
adjusting a ratio between the first time width and the second time width according to the sensing signal.

32. The sensor-controlled method of claim 27, wherein the at least one light emitting unit comprises a plurality of light emitting units, and the sensor-controlled method further comprises:
generating a synchronization signal; and
enabling the light emitting units to simultaneously operate at the non-emission state according to the synchronization signal;
wherein during a period in which each of the light emitting units operates at the non-emission state, the surrounding luminance is sensed to generate the sensing signal.
